(19) United States
(12) Patent Application Publication
(10) Pub. No.: US 2003/0048890 A1
(43) Pub. Date: Mar. 13, 2003

(54) System and method for changing a personal identification number

(76) Inventors: David L. Weiss, Glen Allen, VA (US); Robert Michael Steele, Richmond, VA (US); Anand Ramamoorthy, Richmond, VA (US)

Correspondence Address: BAKER & MCKENZIE, 805 THIRD AVENUE, NEW YORK, NY, 10022, US

(21) Appl. No.: 09/950,188

(22) Filed: Sep. 10, 2001

(51) Int. Cl. H04M 3/42

(52) U.S. Cl. 379/201.02

(57) ABSTRACT

Method for changing a previously assigned personal identification number using a voice response unit. The method includes receiving a new personal identification number input by a user interacting with the voice response unit, determining whether the new personal identification number is valid, and changing the previously assigned personal identification number to the new personal identification number without requiring the user to input the previously assigned personal identification number if the new personal identification number is valid.

### FIELD

The present application relates to a system and method for changing a personal identification number and, more particularly, to a system and method that enables a user to change a previously assigned personal identification number using a voice response unit without having to disclose the previously assigned personal identification number.

### BACKGROUND

Voice response units (“VRUs”) enable users to access information using a conventional touch tone telephone. The interaction between the users and the voice response unit includes various voice prompts output by the voice response unit and responses thereto, for example, via the telephone keypad, by the user. Voice response units are used by service providers, such as banks and credit card companies, to fully or partially automate telephone call answering or responding to queries. Typically a voice response unit provides the capability to play voice prompts including recorded voice segments or speech synthesized from text and to receive responses thereto. The voice prompts are generally organized in the form of voice menus invoked by state tables. A state table can access and play a voice segment or synthesize speech from given text. The prompts are usually part of a voice application that is designed to, for example, allow a user to query information associated with their various accounts.

Further, voice response units are used in a variety of applications today to resolve customer problems and questions in conjunction with customer service representatives. In a financial service industry, such voice response units often provide users general information via one or more automated messages. Usually, the user is also given the option to either bypass an automated message or after the automated message has concluded to interact with a customer service representative in order to receive more detailed information tailored to an account of the user.

For example, a user may call a financial service institution regarding a personal identification number (“PIN”). A PIN is a series of numbers, a series of letters or a combination of one or more numbers and one or more letters that are associated with a card of a user and allows a user, for example, to use the card to withdraw money from an automated teller machine (“ATM”). Specifically, the user may call the financial service institution in order to assign a PIN to a new card, such as a credit card, or to change a PIN already assigned to a card, for example, because the user forgets the previously assigned PIN or the previously assigned PIN is too difficult for the user to remember. In order to assign/change a PIN, a user must often speak with a customer service representative. A user can interact, however, with a VRU to change a PIN, but the user is prompted to first enter the old PIN. Since many users forget a previously assigned PIN and therefore call the financial service institution to change the PIN, such users cannot change the PIN using the VRU and must resort to speaking with a customer service representative or write in to request a copy of your PIN and to change the PIN. Consequently, financial service institutions, such as credit card companies, incur tremendous expenses in having to handle these calls with customer service representatives, as opposed to having the calls handled solely through the voice response unit.

Accordingly, a need exists for a system and method that enables a user to change a previously assigned PIN to a new PIN by interacting with a VRU and without having to disclose the previously assigned PIN.

### SUMMARY OF THE INVENTION

An aspect of the present application provides for a method for changing a previously assigned personal identification number using a voice response unit. The method includes receiving a new personal identification number input by a user interacting with the voice response unit, determining whether the new personal identification number is valid, and changing the previously assigned personal identification number to the new personal identification number without requiring the user to input the previously assigned personal identification number if the new personal identification number is valid.

An additional aspect of the present application provides for a method for changing a previously assigned personal identification number using a voice response unit. The method includes prompting a user interacting with the voice response unit to input verification data, receiving the verification data input by the user, authenticating the user according to the verification data, receiving a request from the user to change the previously assigned personal identification number after the user is verified, prompting the user to input additional verification data after receiving the request, receiving the additional verification data input by the user, authenticating the additional verification data, prompting the user to input a new personal identification number, receiving the new personal identification number input by the user, determining whether the new personal identification number is valid, and changing the previously assigned personal identification number to the new personal identification number without requiring the user to input the previously assigned personal identification number if it is determined that the new personal identification number is valid.

A further aspect of the present application provides for a system for changing a previously assigned personal identification number, including a voice response unit for prompting a user to input a new personal identification number, and a processor coupled to the voice response unit and operable for determining whether the new personal identification number input by the user is valid and for changing the previously assigned personal identification number to the new personal identification number without requiring the user to input the previously assigned personal identification number if it is determined that the new personal identification number is valid.

### BRIEF DESCRIPTION OF THE DRAWINGS

FIG. 1 illustrates an exemplary self-select PIN system of the present application; and

FIG. 2 illustrates an exemplary flow diagram for changing a PIN of the present application.

### DETAILED DESCRIPTION

The exemplary embodiments of the present application are explained with reference to a user interacting with a voice response unit (“VRU”) in order to change a previously assigned PIN associated with a credit card. The present application, however, is not limited to PINS associated with credit cards and credit card companies. Rather, PINs can be associated with other types of cards, such as debit cards and smart cards, and various accounts of a user that may be unrelated to the finances of the user. Moreover, the term PIN is used in the present application to mean any series of numbers, any series of letters or a combination of one or more numbers and one or more letters that act as security for a respective card or account.

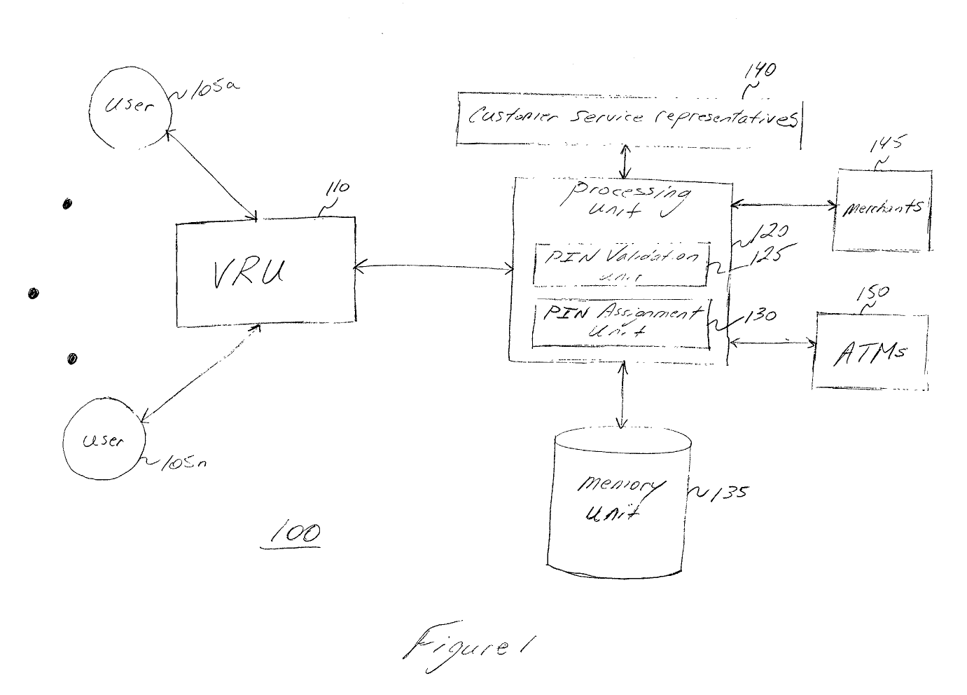

FIG. 1 illustrates an exemplary self-select PIN system 100 of the present application. As can be seen in FIG. 1, self-select PIN system 100 includes VRU 110, a plurality of users 105a . . . 105n that can interact with VRU 110, memory unit 135, processing unit 120 coupled to VRU 110 and memory unit 135, customer service representatives 140, merchants 145 and ATMs 150, each coupled to processing unit 120. Processing unit 120 includes PIN validation unit 125 and PIN assignment unit 130. In an exemplary embodiment, users 105a . . . 105n are individuals using communication devices, such as wired or wireless telephones and/or network connections, for example, Internet connections, via a wired or wireless transmission link to interact with VRU 110. Other communication devices can be used by users 105a . . . 105n as well. Further, memory unit 135 can include various types of memory storage devices, for example, one or more databases. Memory unit 135 can store, for example, data associated with users 105a . . . 105n and their respective credit card accounts, including PINs associated with credit cards of the users 105a . . . 105n. The components of FIG. 1 may be implemented through hardware, software, and/or firmware. Further, the number of components in self select PIN system 100 is not limited to what is illustrated.

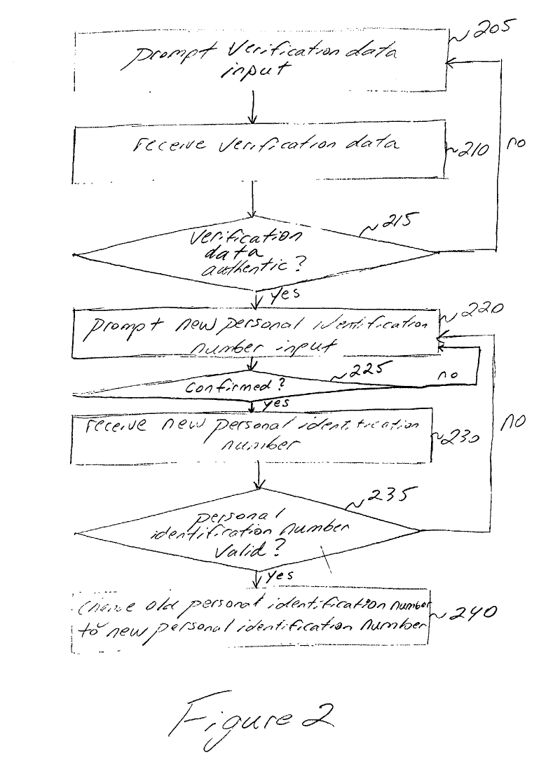

FIG. 2 illustrates an exemplary flow diagram for changing a previously assigned PIN of the present application. One of the users 105a . . . 105n, for example, user 105a, may want to change a previously assigned PIN because user 105a forgot the PIN associated with a credit card. In addition, user 105a may desire to change a PIN generated by the credit card company and automatically associated with the credit card. User 105a may or may not be aware that a PIN was automatically associated with the credit card. For example, user 105a may call the credit card company regarding a new credit card to assign a PIN thereto, not knowing that the credit card company automatically associated a PIN with the credit card. In any event, user 105a contacts the credit card company and interacts with VRU 110 to change the previously assigned PIN. User 105a perceives this process as creating a new PIN.

Specifically, user 105a calls the credit card company and is presented with a menu of options by VRU 110. User 105a selects an entry in the menu of options, for example, by pressing a predetermined key on a telephone key pad. One of the entries in the menu informs user 105a that by selecting that particular entry user 105a can change a PIN. Alternatively, user 105a may be presented with one or more sub-menus of options including the entry for changing a PIN.

Before or after the menu of options is presented to user 105a, user 105a is identified and verified by processing unit 120. User 105a can be identified by processing unit 120, for example, based on an account number input by user 105a. In addition, processing unit 120 performs verification by matching one or more inputs by user 105a, such as a social security or insurance number or a portion of a social security or insurance number, a unique identifier assigned to user 105a, a date of birth, a zip code, a telephone number or a portion of a telephone number, a maiden name and any other unique identifier, or any combination thereof, with information stored in memory unit 135 regarding user 105a.

Once user 105a has been identified and verified and has selected the entry enabling a PIN change, user 105a is prompted by VRU 110 to input additional verification data, in 205. The verification data provides processing unit 120 an additional way to verify that user 105a is the appropriate person associated with the respective credit card and is thus authorized to change the PIN. The verification data can include a social security or insurance number or a portion of the social security or insurance number, a unique identifier assigned to user 105a, a date of birth, a zip code, a telephone number or a portion of a telephone number, a maiden name and any other unique identifier, or any combination thereof. In an alternative embodiment, user 105a is not prompted to input additional verification data. Rather, the initial data input by user 105a and used to identify and verify user 105a is utilized by processing unit 120. The additional verification data, or the initial data, input by user 105a is received by processing unit 120 via VRU 110, in 210, and is authenticated by processing unit 120, in 215. Processing unit 120 authenticates the verification data by comparing the verification data to information stored in memory unit 135 that is associated with user 105a.

If processing unit 120 confirms that the verification data input by user 105a is valid, VRU 110 prompts user 105a to input a new PIN in order to change the previously assigned PIN, in 220. User 105a is not prompted by VRU 110 to input the previously assigned PIN in order to change the previously assigned PIN. User 105a inputs a PIN by either pressing or saying the appropriate numbers and/or letters. The PIN can be a series of numbers, a series of letters or a combination of one or more numbers and one or more letters. For example, the new PIN can be four digits, such as 1234. The new PIN input by user 105a is read back to user 105a by VRU 110 in order for user 105a to confirm, in 225. User 105a is prompted, for example, to press a predetermined key to indicate approval or to press another predetermined key to indicate that user 105a does not approve the read back PIN. If user 105a indicates disapproval with the read back PIN, user 105a is again prompted by VRU 110 to input a new PIN in order to change the previously assigned PIN, in 220.

Alternatively, user 105a can be prompted to again input the new PIN to confirm that user 105a inputted the correct PIN the first time. Processing unit 120 compares the two inputted PINs to verify that the PINs are the same. If the PINs are not the same, user 105a is prompted to input the new PIN until two subsequent PINs match.

If processing unit 120 determines that the validation data input by user 105a is not valid, for example, does not match information stored in memory unit 135 associated with user 105a, user 105a can be prompted to again input the verification data or can be transferred to customer service representative 140.

The new PIN input by user 105a is received by processing unit 120 via VRU 110, in 230. PIN validation unit 125 of processing unit 120 determines whether the new PIN is valid, in 235. For example, the new PIN is valid if the new PIN does not begin with a predetermined number or letter, does not contain a predetermined sign, such as the # sign or * sign, is a predetermined length or the length is within a predetermined range, is not associated with a PIN previously associated with user 105a and/or is not the same PIN of other users 105b . . . 105n. As will be appreciated by a person of ordinary skill in the art, the validity of a PIN input by one of the users 105a . . . 105n can be determined according to various other criteria.

If PIN validation unit 125 determines that the new PIN is not valid, user 105a is prompted via VRU 110 to input a different PIN. The new PIN is confirmed as described above, in 220. In an alternative embodiment, user 105a is transferred to customer service representative 140 by processor 120 when a predetermined number of unsuccessful attempts have been made by user 105a to select a new PIN. It should be noted that user 105a can press a predetermined key on a key pad or say a predetermined word or phrase to be connected to customer service representative 140 while interacting with VRU 110 at any point shown in FIG. 2.

Upon PIN validation unit 125 determining that the new PIN is valid, PIN assignment unit 130 of processing unit 120 associates the new PIN with the respective credit card and credit card account, in 240. More particularly, PIN assignment unit 130 changes the previously assigned PIN stored in memory unit 135 to the new PIN, in 240. The new PIN is stored in memory unit 135 in association with the respective credit card and the credit card account of user 105a. The previously assigned PIN is changed to the new PIN in real-time and, as a result, user 105a can immediately utilize the new PIN after interacting with VRU 110.

Accordingly, user 105a can, for example, use the credit card at merchant 145 to make a purchase or at ATM 150 to withdraw money if a PIN is required by merchant 145 or ATM 150 to use the credit card. After user 105a inputs the new PIN at merchant 145 or ATM 150, merchant 145 or ATM 150 verifies the PIN by transmitting data including the inputted PIN to processor 120. Processor 120 compares the PIN input at merchant 145 or ATM 150 to the new PIN associated with the respective credit card stored in memory unit 135. If the PIN input by user 105a matches the new PIN, user 105a is authorized to proceed with making the purchase at merchant 145 or withdrawing money from ATM 150. On the other hand, if the PIN does not match, user 105a can be notified that the inputted PIN is incorrect and/or prompted to re-input the PIN.

Cards, such as credit cards, having a PIN associated therewith can obviously be used by users 105a . . . 105n at places other than merchants and ATMs, as shown in FIG. 1. Further, the implementation for using cards, for example, to credit or debit an account, to withdraw money and to access account information is well known in the art, as well as the process of assigning PINs to such cards, and is therefore not explained in detail herein.

The embodiments described above are illustrative examples of the present invention and it should not be construed that the present invention is limited to these particular embodiments. Various changes and modifications may be effected by one skilled in the art without departing from the spirit or scope of the invention as defined in the appended claims.

What is claimed is:

1. A method for changing a previously assigned personal identification number using a voice response unit, comprising:
receiving a new personal identification number input by a user interacting with the voice response unit;
determining whether the new personal identification number is valid; and
changing the previously assigned personal identification number to the new personal identification number without requiring the user to input the previously assigned personal identification number if the new personal identification number is valid.

2. The method for changing a previously assigned personal identification number using a voice response unit as set forth in claim 1, further comprising:
verifying the user interacting with the voice response unit.

3. The method for changing a previously assigned personal identification number using a voice response unit as set forth in claim 2, wherein
verifying the user interacting with the voice response unit includes
prompting the user to input verification data and comparing the received verification data to information stored in a memory unit.

4. The method for changing a previously assigned personal identification number using a voice response unit as set forth in claim 3, wherein
the verification data includes one or more numbers and/or one or more words associated with the user and stored in the memory unit.

5. The method for changing a previously assigned personal identification number using a voice response unit as set forth in claim 1, wherein
determining whether the new personal identification number is valid includes at least one of determining if the new personal identification number begins with a predetermined number or a predetermined letter, determining if the new personal identification number is a predetermined length or the length of the PIN is within a predetermined range and determining if the new personal identification number is the same as one or more other personal identification numbers.

6. The method for changing a previously assigned personal identification number using a voice response unit as set forth in claim 1, further comprising:
notifying the user through the voice response unit that the new personal identification number has been assigned to a card.

7. The method for changing a previously assigned personal identification number using a voice response unit as set forth in claim 6, wherein
the card is a credit card.

8. The method for changing a previously assigned personal identification number using a voice response unit as set forth in claim 6, wherein
the card is a debit card.

9. The method for changing a previously assigned personal identification number using a voice response unit as set forth in claim 6, wherein
the card is a smart card.

10. The method for changing a previously assigned personal identification number using a voice response unit as set forth in claim 1, wherein
the previously assigned personal identification number and the new personal identification number have a length of four digits.

11. A method for changing a previously assigned personal identification number using a voice response unit, the method comprising:
prompting a user interacting with the voice response unit to input verification data;
receiving the verification data input by the user;
authenticating the user according to the verification data;
receiving a request from the user to change the previously assigned personal identification number after the user is verified;
prompting the user to input additional verification data after receiving the request;
receiving the additional verification data input by the user;
authenticating the additional verification data;
prompting the user to input a new personal identification number;
receiving the new personal identification number input by the user;
determining whether the new personal identification number is valid; and
changing the previously assigned personal identification number to the new personal identification number without requiring the user to input the previously assigned personal identification number if it is determined that the new personal identification number is valid.

12. The method for changing a previously assigned personal identification number using a voice response unit as set forth in claim 11, wherein
authenticating the user according to the verification data includes comparing the received verification data to information stored in a memory unit.

13. The method for changing a previously assigned personal identification number using a voice response unit as set forth in claim 11, wherein
the verification data includes one or more numbers and/or one or more words associated with the user and stored in the memory unit.

14. The method for changing a previously assigned personal identification number using a voice response unit as set forth in claim 11, wherein
determining whether the new personal identification number is valid includes at least one of determining if the new personal identification number begins with a predetermined number or a predetermined letter, determining if the new personal identification number is a predetermined length or the length of the PIN is within a predetermined range and determining if the new personal identification number is the same as one or more other personal identification numbers.

15. The method for changing a previously assigned personal identification number using a voice response unit as set forth in claim 11, further comprising:
notifying the user through the voice response unit that the new personal identification number has been associated with a card or an account.

16. The method for changing a previously assigned personal identification number using a voice response unit as set forth in claim 15, wherein
the card is a credit card.

17. The method for changing a previously assigned personal identification number using a voice response unit as set forth in claim 15, wherein
the card is a debit card.

18. The method for changing a previously assigned personal identification number using a voice response unit as set forth in claim 15, wherein
the card is a smart card.

19. The method for changing a previously assigned personal identification number using a voice response unit as set forth in claim 15, wherein
the previously assigned personal identification number and the new personal identification number have a length of four digits.

20. A system for changing a previously assigned personal identification number, comprising:
a voice response unit for prompting a user to input a new personal identification number; and
a processor coupled to the voice response unit and operable for determining whether the new personal identification number input by the user is valid and for changing the previously assigned personal identification number to the new personal identification number without requiring the user to input the previously assigned personal identification number if it is determined that the new personal identification number is valid.
